(19) United States
(12) Patent Application Publication
(10) Pub. No.: US 2026/0343099 A1
(43) Pub. Date: Oct. 29, 2026

(54) POSITION ESTIMATING DEVICE AND METHOD

(71) Applicant: INAVI SYSTEMS CORPORATION, Seongnam-si, Gyeonggi-do (KR)

(72) Inventors: Han Soo JUNG, Anyang-si (KR); Taeg Han KIM, Yongin-si (KR)

(73) Assignee: INAVI SYSTEMS CORPORATION, Seongnam-si, Gyeonggi-do (KR)

(21) Appl. No.: 19/102,544

(22) PCT Filed: Aug. 7, 2023
(86) PCT No.: PCT/KR2023/011603

§ 371 Date: Feb. 10, 2025

(30) Foreign Application Priority Data
Aug. 8, 2022 (KR) 10-2022-0098513
Aug. 1, 2023 (KR) 10-2023-0100709

(51) Int. Cl. H04N 23/695; G06T 7/292; G06T 7/73; G06V 20/54; G06V 20/62; H04N 23/61; H04N 23/90

(52) U.S. Cl. CPC H04N 23/695; G06T 7/292; G06T 7/74; G06V 20/54; G06V 20/625; H04N 23/61; H04N 23/90; G06T 2207/30232; G06T 2207/30236

(57) ABSTRACT

A position estimating device, according to one embodiment disclosed in the present document, comprises: a communication module providing a short-range communication channel within a GPS or RTK shaded area; first and second camera modules spaced apart from each other at a predetermined distance and capable of rotating at least laterally; and a processor. The processor may: obtain a first lateral angle value between the second camera module and a vehicle in the shaded area using the first camera module; obtain a second lateral angle value between the first camera module and the vehicle using the second camera module; estimate the position of the vehicle; and transmit information related to the estimated position to the vehicle through the short-range communication channel.

### CROSS-REFERENCE TO RELATED APPLICATIONS

This application is the U.S. National Stage of International Application No. PCT/KR2023/011603 filed Aug. 7, 2023, which claims benefit of priority to Korean Patent Application No. 10-2023-0100709 filed Aug. 1, 2023, and to Korean Patent Application No. 10-2022-0098513 filed Aug. 8, 2022, the entire content of which is incorporated herein by reference.

### TECHNICAL FIELD

This research was conducted as part of Autonomous Driving Technology Development (20018198) supported by Ministry of Trade, Industry and Energy and Korea Evaluation Institute of Industrial Technology.

Various embodiments disclosed in this document are related to a vehicle location estimation technology.

### BACKGROUND ART

The location of a vehicle may be estimated based on a global positioning system (GPS) or real-time kinematic (RTK) positioning. However, the GPS or RTK signal may not be received within a tunnel or in a shadow area, such as a road surrounded by skyscrapers.

### DISCLOSURE

### Technical Problem

In a shadow area, the location of a vehicle may be estimated by using both the location of the vehicle estimated in a GPS coverage area and motion information of the vehicle. However, the location of a vehicle estimated in a corresponding way may not be accurate. Moreover, there is a need for a scheme for accurately estimating the location of a vehicle because it is very important to accurately estimate the location of the vehicle in an advanced driver support device, such as an autonomous driving system.

Various embodiments disclosed in this document may provide a location estimation device and method capable of estimating the location of a vehicle in a shadow area.

### Technical Solution

A location estimation device according to an embodiment disclosed in this document includes a communication module configured to provide a short-distance communication channel within a GPS or RTK shadow area, first and second camera modules spaced apart from each other at a predetermined interval so that a road within the shadow area is photographed and each provided to be capable of being at least laterally rotated, a processor functionally connected to the first camera module, the second camera module, and the communication module. The processor may obtain a first lateral angle value between the second camera module and one vehicle within the shadow area by using the first camera module, may obtain a second lateral angle value between the first camera module and the one vehicle by using the second camera module, may estimate a location of the one vehicle through triangulation using the first lateral angle value, the second lateral angle value, and a separation distance between the first and second cameras, and may transmit information related to the estimated location to the one vehicle through the short-distance communication channel.

Furthermore, a location estimation method using first and second camera modules spaced apart from each other at a designated distance so that a road within a shadow area is photographed and each provided to be capable of being rotated at least toward one side, according to an embodiment disclosed in this document, may include an operation of detecting one vehicle that travels on the road within the shadow area by using the first and second camera modules, an operation of controlling rotation of the first camera module and the second camera module so that the first camera module and the second camera module are directed toward the one vehicle, an operation of obtaining lateral angle values between the first and second camera modules, respectively, and the one vehicle on the basis of a line that connects the first camera module and the second camera module, at first timing at which the first and second camera modules are directed toward the one vehicle, an operation of obtaining up and down angle values of the first and second camera modules, which are based on perpendiculars that connect the first and second camera modules and a reference plane, at the first timing, and an operation of estimation a location of the one vehicle through triangulation based on the lateral angle values and the up and down angle values.

### Advantageous Effects

According to various embodiments disclosed in this document, the location of a vehicle can be estimated in a shadow area. In addition, various effects which may be checked directly or indirectly through this document may be provided.

### BRIEF DESCRIPTION OF DRAWINGS

FIG. 1 is an environment in which a location estimation device according to an embodiment is embodied.

FIG. 2 is a diagram for describing a scheme for detecting the location of a vehicle according to an embodiment.

FIG. 3 is a construction diagram of a location estimation device according to an embodiment.

FIG. 4 is a diagram for describing a location estimation method based on triangulation according to an embodiment.

FIG. 5 is a flowchart of a scheme for estimating a location according to an embodiment.

FIG. 6 is a diagram for describing a location estimation method according to another embodiment.

In relation to the description of the drawings, the same or similar reference numeral may be used for the same or similar component.

### MODE FOR INVENTION

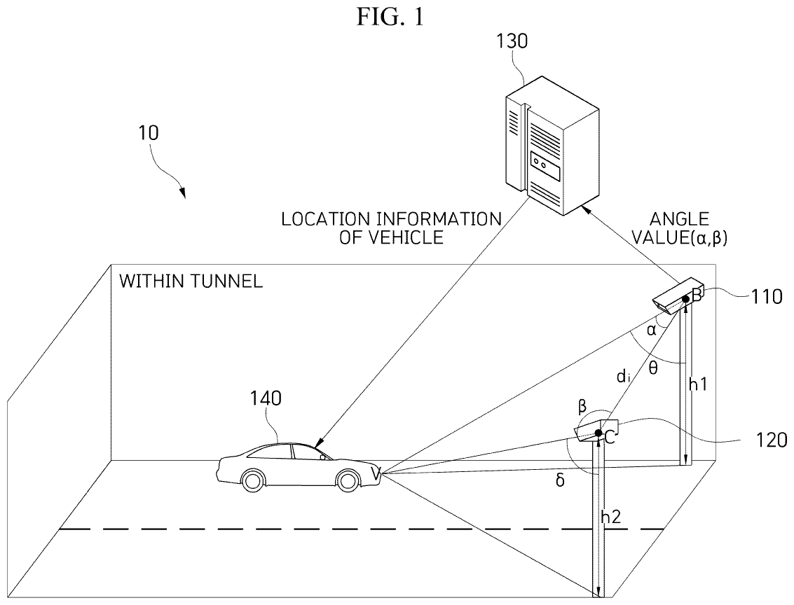

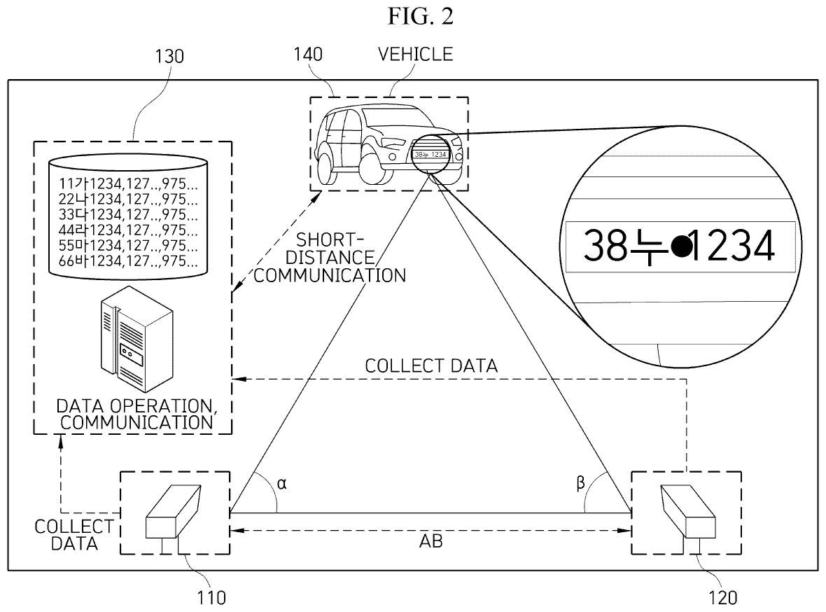

FIG. 1 illustrates an environment in which a location estimation device according to an embodiment is embodied. FIG. 2 is a diagram for describing a scheme for detecting the location of a vehicle according to an embodiment.

Referring to FIGS. 1 and 2, a location estimation system 10 may include a first fixing device 110, a second fixing device 120, a location estimation device 130, and a user device 140.

According to an embodiment, the first fixing device 110 and the second fixing device 120 may each be a device including a camera, such as CCTV equipment installed in a GPS or RTK shadow area (may be mentioned as a “shadow area” hereinafter), for example. The shadow area may include an area where a GPS signal or an RTK signal cannot be received, such as an indoor parking lot, under an overpass, an underpass, or a tunnel, for example. For example, the first and second fixing devices 110 and 120 may be provided on the left and right sides of a road within a shadow area, respectively.

According to an embodiment, the first and second fixing devices 110 and 120 may be disposed within a shadow area by being spaced apart from each other at a predetermined interval (may be mentioned as a “designated separation distance” hereinafter) (e.g., 1 m) or more. For example, the first fixing device 110 may be provided on a first side (e.g., the left) of a road within a shadow area. The second fixing device 120 may be provided on a second side (e.g., the right) of the road within the shadow area.

According to an embodiment, the first and second fixing devices 110 and 120 may be provided at designated heights h1 and h2, respectively, at which the license plate of a vehicle is separately photographed on a road within a shadow area. For example, the first and second fixing devices 110 and 120 (or cameras included in the first and second fixing devices 110 and 120) may each be provided at a height at which the license plate of a preceding vehicle and the license plate of a following vehicle, which travel on a plurality of roads within a shadow area, may be divisively photographed.

According to an embodiment, the first and second fixing devices 110 and 120 may each include a camera module provided to be capable of being rotated toward at least one side. Referring to FIG. 2, for example, the first fixing device 110 may sense and obtain a first (lateral) angle value between the second fixing device 120 and the license plate of one vehicle on the basis of the first fixing device 110 as the first fixing device photographs the license plate of the one vehicle while rotating. The second fixing device 120 may sense and obtain a second (lateral) angle value between the first fixing device 110 and the license plate of the one vehicle on the basis of the second fixing device 120 as the second fixing device photographs the license plate of the one vehicle while rotating.

According to an embodiment, the first and second fixing devices 110 and 120 may transmit, to the location estimation device 130, first and second sensing data including identification information, sensing (photographing) time information, license plate information of the one vehicle, and detected first and second (lateral/up and down) angle values of the first and second fixing devices 110 and 120 through a first designated communication channel. The first designated communication channel may include at least one designated communication channel, among LAN, FTTH, or xDSL, for example.

According to an embodiment, the location estimation device 130 may include a business operator server that provides at least one designated service, among traffic information (e.g., TPEG) provision service, a route guidance service (e.g., TMAP), or a black box data-based service, for example. Alternatively, the location estimation device 130 may be a service use terminal provided by a business operator server that provides the designated service.

According to an embodiment, the location estimation device 130 may receive first and second sensing data from the first and second fixing devices 110 and 120, respectively, through a first designated communication channel, and may determine (e.g., estimate) the location of one vehicle based on the first and second sensing data. For example, the location estimation device 130 may check a first lateral angle value (α) between the second fixing device 120 and one vehicle, which is based on the first fixing device 110, and a second lateral angle value (β) between the second fixing device 120 and the one vehicle, which is based on the second fixing device, based on the first and second sensing data. The location estimation device 130 may estimate a distance from the one vehicle through triangulation using the first lateral angle value (α), the second lateral angle value (β), and a separation distance (dᵢ) between the first fixing device 110 and the second fixing device.

According to an embodiment, the location estimation device 130 may store an HD map related to three-dimensional (3-D) location information (latitude, longitude, and altitude) of each of the first and second fixing devices 110 and 120, the distance (dᵢ) between the first fixing device 110 and the second fixing device 120, and road information (e.g., the altitude of a road) within a shadow area.

According to an embodiment, the location estimation device 130 may estimate the location of one vehicle by considering the altitude of a road on which one vehicle is travelling based on an HD map. In relation thereto, when receiving first and second sensing data from the first fixing device 110 and the second fixing device 120, respectively, the location estimation device 130 may check that the first and second lateral angle values (α and β) relate to the same one vehicle based on license plate information included in the first and second sensing data. Furthermore, the location estimation device 130 may check the first and second lateral angle values detected at the same time, based on sensing time information included in the first and second sensing data. Alternatively, the location estimation device 130 may check the separation distance (dᵢ) between the first fixing device 110 and the second fixing device 120, which has been previously stored (or set) based on identification information of the first fixing device 110 and the second fixing device 120, which is included in the first and second sensing data.

In an embodiment, the location estimation device 130 may estimate the location of one vehicle based on the up and down angles (θ and δ) between the first fixing device 110 and the second fixing device 120 and the reference plane, and detailed components thereof are described later.

According to an embodiment, the location estimation device 130 may transmit estimated location information (3-D location information) of one vehicle to the user device 140 through a second designated communication channel. The second designated communication channel may include at least one short-distance communication channel, among radio frequency identification (RFID), near field communication (NFC), Bluetooth, Wi-Fi, or WiBro, for example. In relation thereto, the location estimation device 130 may have at least a part (e.g., a communication module) provided in a shadow area, and may be provided to be capable of communicating with one vehicle that passes through the shadow area.

According to an embodiment, the user device 140 may be a device that provides a user (e.g., a driver) with a designated service, such as the guidance/storage of route information, based on location information of one vehicle that is received from the location estimation device 130. For example, the user device 140 may be a device, such as an autonomous driving system, a driver support device, a navigation device, or a black box.

According to various embodiments, the user device 140 may request location information of one vehicle from the location estimation device 130 while providing a designated service. The location estimation device 130 may receive first and second sensing data from the first fixing device 110 and the second fixing device 120, respectively, in response to the request from the user device 140, and may provide the location information of the one vehicle based on the first and second sensing data. For example, the user device 140 may request location information of one vehicle from the location estimation device 130, when confirming a failure state of an inertial device included therein, the degradation of reliability, a caution section (e.g., a fork in a tunnel) within a shadow area, or a state in which the user device cannot estimate (has a difficulty in estimating) the location information of the one vehicle.

According to various embodiments, at least some operation, among operations of the location estimation device 130, may be performed by at least one device, among the first fixing device 110, the second fixing device 120, or the user device 140. For example, if at least one of the first fixing device 110 or the second fixing device 120 provides a short-distance communication channel, the location estimation device 130 may transmit location information to one vehicle through the at least one fixing device. In this document, for convenience of description, a case in which the location estimation device 130 directly transmits location information to one vehicle is described as an example. However, the present disclosure is not limited thereto.

According to various embodiments, the location estimation device 130 may include the first fixing device 110 or the second fixing device 120. In this document, for convenience of description, a case in which the first fixing device 110 and the second fixing device 120 are camera modules included in the location estimation device 130 is described as an example. However, the present disclosure is not limited thereto.

According to the embodiment, it has been described that the location of a vehicle that is travelling within a shadow area is calculated by using the two fixing devices 110 and 120 installed at fixed locations within a global positioning system (GPS) and real-time kinematic (RTK) positioning shadow area, such as an indoor parking lot, under an overpass, an underpass, or a tunnel. However, according to various embodiments, the user device 140 may calculate the location of a vehicle based on two angle values, which are obtained by recognizing two markers installed at fixed location within a shadow area through an image photographing module mounted on the vehicle, and a distance between the two markers.

As described above, the location estimation device 130 according to an embodiment can accurately estimate the location of a vehicle based on 3-D location information of a corresponding device and a rotation angle thereof by using devices (e.g., the first and second fixing devices 110 and 120 of FIG. 1) included therein, which may sense the location of the vehicle on a road within a GPS or RTK shadow area or in association with the devices.

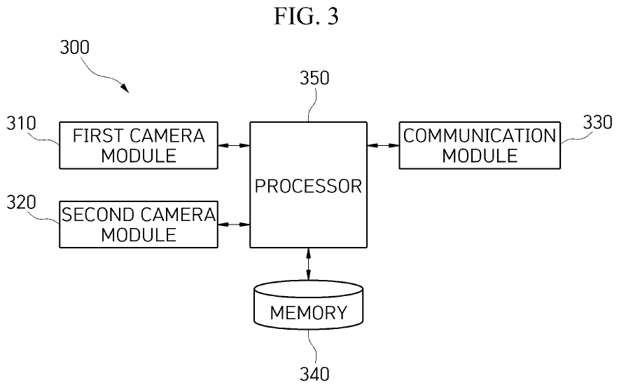

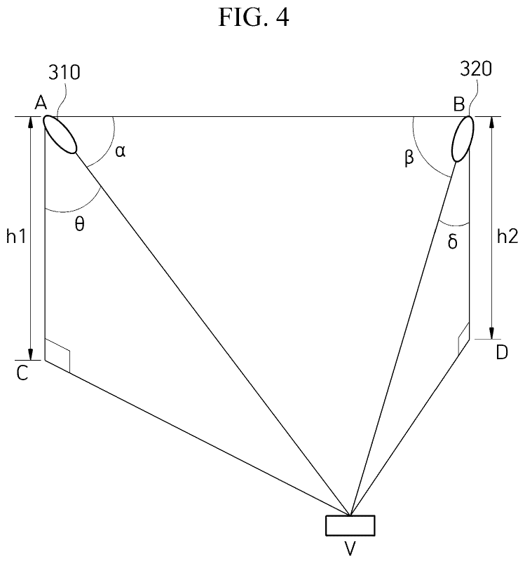

FIG. 3 illustrates a construction diagram of a location estimation device according to an embodiment. FIG. 4 is a diagram for describing a location estimation method based on triangulation according to an embodiment.

Referring to FIG. 3, a location estimation device 300 according to an embodiment may include a first camera module 310, a second camera module 320, a communication module 330, memory 340, and a processor 350. In an embodiment, some components of the location estimation device 300 may be omitted or an additional component may be further included in the location estimation device. Some of the components of the location estimation device 300 may be combined into one entity, but may identically perform a function of corresponding components prior to the combination. For example, the first camera module 310 and the second camera module 320 may be provided in at least one first device (e.g., the first fixing device 110 and the second fixing device 120 of FIG. 1). At least some of the processor 350 and memory 340 of the communication module 330 may be provided in a second device (e.g., the location estimation device 300 of FIG. 1), and may mutually transmit and receive data through the first designated communication channel. In this case, other some of the processor 350, the communication module 330, and the memory 340 may be included in the at least one first device.

According to an embodiment, the first and second camera modules 310 and 320 may be spaced apart from each other at a predetermined interval and provided on at least one side (e.g., left and right sides, respectively) of a road within a shadow area at designated heights. The designated heights are heights (e.g., each about 2 m) at which the license plate of a preceding vehicle and the license plate of a following vehicle that are spaced apart from each other at a designated distance (e.g., 1 m) or more can be separately sensed or photographed, and may be experimentally determined.

According to an embodiment, the first and second camera modules 310 and 320 may be provided so that the photographing direction of each of the first and second camera modules can be rotated (or switched) to at least one side (e.g., the left or the right) through a motor member. The first and second camera modules 310 and 320 may be provided to photograph the license plate of a vehicle that travels on a road within a shadow area. For example, the first and second camera modules 310 and 320 may be provided or installed so that the first and second camera modules can photograph a corresponding road at a predetermined angle (or provided to rotate up and down) to a road within a shadow area up and down while looking down obliquely.

According to an embodiment, the first and second camera modules 310 and 320 may each include at least one image sensor, among a charge coupled device (CCD) and a metal oxide semiconductor (MOS). The first and second camera modules 310 and 320 may photograph the license plate of a vehicle under the control of the processor 350.

The communication module 330 may support the establishment of a wired/wireless communication channel between the location estimation device 300 and another apparatus (e.g., the user device 140) and the execution of communication through the established communication channel. The communication channel may include a short-distance communication channel (e.g., the second designated communication channel), for example. The short-distance communication channel may include at least one short-distance communication channel, among radio frequency identification (RFID), near field communication (NFC), Bluetooth, Wi-Fi, or WiBro, for example. If the first and second camera modules 310 and 320 and the processor 350 are mutually connected by the first designated communication channel, the first and second camera modules and the processor may be provided to further support the first designated communication channel. The first designated communication channel may include at least one designated communication channel, among a LAN, FTTH, or xDSL, for example. In contrast, the first designated channel may include a long-distance/short-distance communication channel.

The memory 340 may store various data that are used by at least one component (e.g., the processor 350) of the location estimation device 300. The data may include software and the input data or output data of a command related thereto, for example. For example, the memory 340 may store at least one instruction for estimating the location of one vehicle. According to an embodiment, the memory 340 may store first location information related to a 3-D location of the first camera module 310 and second location information related to a 3-D location of the second camera module 320. The memory 340 may further store the separation distance (dᵢ) between the first camera module 310 and the second camera module 320, which is confirmed based on the first location information and the second location information. The memory 340 may further store vertical heights h1 and h2 of the first camera module 310 and the second camera module 320. The memory 340 may store an HD map related to the first location information and the second location information.

The memory 340 may include various forms of volatile memory or nonvolatile memory. For example, the memory may include read only memory (ROM) and random access memory (RAM). In an embodiment of this specification, the memory may be disposed inside or outside the processor. The memory 340 may be connected to the processor 350 through various already-known means.

The processor 350 may control at least another component (e.g., a hardware or software component) of the location estimation device 300, and may perform various data processing or operations. The processor 350 may include at least one of a central processing unit (CPU), a graphic processing unit (GPU), a microphone processor, an application processor, an application specific integrated circuit (ASIC), or a field programmable gate arrays (FPGA), for example, and may have a plurality of cores.

According to an embodiment, the processor 350 may monitor a road within a shadow area through the first camera module 310 and the second camera module 320 that are provided (installed) within the shadow area. When checking one vehicle (e.g., the license plate of the one vehicle) not checked in a photographing image before, the processor 350 may track the license plate of the one vehicle (hereinafter may be referred to as “one vehicle”) while rotating the first and second camera modules 310 and 320.

According to an embodiment, the processor 350 may obtain first and second lateral angle values between the first camera module 310 and the second camera module 320, and one vehicle in the state in which a reference point of the first camera module 310 and a reference point (e.g., the optical axis) of the second camera module 320 have been directed toward the license plate of the one vehicle while tracking the license plate of the one vehicle by rotating the first camera module 310 and the second camera module 320 in at least one direction of up and down directions thereof.

In an embodiment, the processor 350 may obtain, as the first lateral angle value, a change in the angle in a second state in which the reference point of the first camera module 310 has been directed toward the license plate of one vehicle (e.g., the central line of the license plate), compared to a first state in which the reference point of the first camera module 310 has been directed toward the second camera module 320. Similarly, the processor 350 may obtain, as the second lateral angle value, a change in the angle in a fourth state in which the reference point of the second camera module 320 has been directed toward the license plate of one vehicle (e.g., the central line of the license plate), compared to a third state in which the reference point of the second camera module 320 has been directed toward the first camera module 310.

According to an embodiment, the processor 350 may obtain a first up and down angle value (θ) of one vehicle, which is based on a first perpendicular that connects the first camera module 310 and a reference plane, and a second up and down angle value (δ) of the one vehicle, which is based on a second perpendicular that connects the second camera module 320 and the reference plane, at first timing at which the first and second lateral angle values (α and β) are obtained.

According to an embodiment, the processor 350 may confirm the separation distance between the first camera module 310 and the second camera module 320 and the heights (the first height h1 and the second height h2) at which the first camera module 310 and the second camera module 320 are installed, respectively, which are stored in the memory 340. In relation thereto, if first (3-D) location information of the first camera module 310 and second (3-D) location information of the second camera module 320 have been stored in the memory 340, the processor 350 may calculate the separation distance, the first height, and the second height, based on the first location information and the second location information. The first height h1 may be an interval between the ground and the reference point of the first camera module 310. Alternatively, the first height h1 may be a height that is obtained by subtracting an interval between the license plate of one vehicle and the ground from the length of the first perpendicular that connects the reference point of the first camera module 310 and the ground. Similarly, the second height h2 may be an interval between the ground and the second camera module 320. Alternatively, the second height h2 may be a height that is obtained by subtracting an interval between the license plate of the one vehicle and the ground from the length of the second perpendicular that connects the reference point of the second camera module 320 and the ground. In relation thereto, the processor 350 may check an interval between the license plate of one vehicle and the ground based on license plate information of the one vehicle from the memory 340, for example, because the location of the license plate of the one vehicle may be different depending on the vehicle.

According to an embodiment, the processor 350 may determine (estimate) a 3-D location of a vehicle, based on a first triangulation operation using first and second lateral angle values obtained at first timing and the separation distance between the first camera module 310 and the second camera module 320, a second triangulation operation using the first up and down angle value obtained the first timing, an angle (90 degrees) of the reference plane and the first perpendicular, and the first height, and a third triangulation operation using the second up and down angle value obtained at the first timing, an angle (90 degrees) of the reference plane and the second perpendicular, and the second height.

Referring to FIG. 4, the reference point of the first camera module 310 is called a point A, the reference point of the second camera module 320 is called a point B, and the location of the license plate of one vehicle is called a point V. The processor 350 may confirm a separation distance AB(=dᵢ) between the first camera module 310 and the second camera module 320 from the memory 340, may check a first lateral angle value (BAV) α between the second camera module 320 and the one vehicle through the lateral rotation of the first camera module 310, and may check a second lateral angle value (ABV) β between the first camera module 310 and the one vehicle through the lateral rotation of the second camera module 320.

sin V=sin(α+β) because <V=180°−(α+β).

Equation 1 below may be established according to the sine rule of a triangle ABC.

$$\frac{sin ( α + β )}{\overline{AB}} = \frac{sin α}{\overline{VB}} = \frac{sin β}{\overline{VA}} \qquad [ Equation 1 ]$$

According to Equation 1, as in Equations 2 and 3 below, the distances between the first and second camera modules 310 and 320, and the one vehicle may be calculated.

$$\overline{VA} = \frac{\overline{AB} sin β}{sin ( α + β )} \qquad [ Equation 2 ]$$

$$\overline{VB} = \frac{\overline{AB} sin α}{sin ( α + β )} \qquad [ Equation 3 ]$$

Referring to FIG. 4, a point at which the first camera module 310 and the reference plane are connected and the reference point of the first camera module 310 and the reference plane are perpendicularly met may be called a point C. A point at which the reference point of the second camera module 320 and the reference plane are perpendicularly met may be called a point D. The point C may be a point spaced apart from the ground at a height at which the license plate of the one vehicle is installed at a point that comes into contact with the ground of the first perpendicular that connects the reference point of the first camera module 310 and the ground, for example. The point D may be a point spaced apart from the ground at a height at which the license plate of the one vehicle is installed at a point that comes into contact with the ground of the second perpendicular that connects the reference point of the second camera module 320 and the ground, for example. The reference plane may be a plane that is formed by the points C, D, and V.

In this case, the processor 350 may confirm the height AC(h₁) of the first camera module 310 and the height BD(h₂) of the second camera module 320 from the memory 340, may check the first up and down angle value (VAC) θ that is formed by the first perpendicular that connects the one vehicle and the first camera module 310, and the first camera module 310 and the reference plane according to the up and down rotation of the first camera module 310, and may check the second up and down angle value (VBD) β that is formed by the second perpendicular that connects the one vehicle and the second camera module 320, and the second camera module 320 and the reference plane. Similarly to Equations 1 to 3, the processor 350 may calculate a distance BV between the first camera module 310 and the one vehicle V and AV between the second camera module 320 and the one vehicle.

According to an embodiment, the processor 350 may distinguish between corresponding photographing images, the first and second lateral angle values, and the first and second up and down angle values for the one vehicle, based on pieces of license plate information of the one vehicle and pieces of sensing time information, which are included in the photographing images included in (or related to), respectively, through the first and second camera modules 310 and 320.

According to an embodiment, the processor 350 may transmit the determined (estimated) location information of the one vehicle to the user device 140 included in the one vehicle, through the second designated communication channel (the short-distance communication channel). In relation thereto, the processor 350 may confirm a communication address (e.g., MAC address) of the one vehicle from the memory 340 based on the license plate information of the one vehicle, which is included in the images that are used to estimate the location information of the one vehicle. The processor 350 may transmit location information of the one vehicle to the user device 140 included in the one vehicle, based on the communication address of the one vehicle.

According to various embodiments, the processor 350 may use a first image captured by the first camera module 310 and a second image captured by the second camera module 320 as a left-eye image and a right-eye image, may use the separation distance between the first camera module 310 and the second camera module 320 as a time different, and may estimate 3-D location coordinate values of one vehicle by performing stereo matching on the first and second images.

According to various embodiments, the first and second camera modules 310 and 320 may each be provided along with distance sensing means, such as radar, a laser, or an infrared sensor. In this case, the processor 350 may estimate 3-D location coordinate values of one vehicle by using a distance between the first and second camera modules 310 and 320 and the license plate of the one vehicle without using at least some of the rotation angles of the first and second camera modules 310 and 320.

According to various embodiments, the processor 350 may estimate the 3-D location of one vehicle based on altitude information of a road on which the one vehicle is travelling from an HD map instead of the first up and down angle value and the second up and down angle value. For example, the processor 350 may check a distance between each of the first and second camera modules 310 and 320 and one vehicle according to triangulation based on the first and second lateral angle values and the separation distance between the first and second camera modules 310 and 320, and may estimate the 3-D location of the one vehicle based on the location of the one vehicle, which meets a line that extends from each of the first and second camera modules 310 and 320 to the corresponding distance, from an HD map. Alternatively, the processor 350 may check the altitude of a road on which one vehicle is travelling based on a change in the location of the one vehicle in an image including license plate information captured by using the first and second camera modules 310 and 320. However, the present disclosure is not limited thereto.

As described above, the location estimation device 300 according to an embodiment can accurately estimate the location of a vehicle even in a caution section, such as a fork within a tunnel, although performance of the vehicle is not guaranteed because the location estimation device can accurately estimate 3-D location coordinate values of the vehicle by using cameras outside the vehicle in a shadow area.

Furthermore, the location estimation device 300 according to an embodiment can estimate 3-D location coordinate values including a lane along which a vehicle is travelling within a shadow area based on an HD map.

Furthermore, the location estimation device 300 according to an embodiment can estimate the location of a vehicle that is located in a wide range of an area within a shadow area by using the first and second camera modules 310 and 320 which may be rotated.

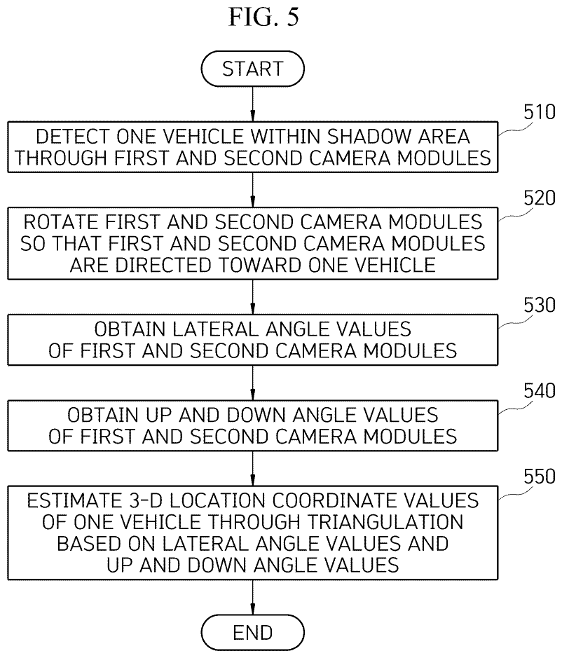

FIG. 5 illustrates a flowchart of a scheme for estimating a location according to an embodiment.

Referring to FIG. 5, in operation 510, the location estimation device 300 may detect one vehicle that travels on a road within a shadow area by using the first and second camera modules 310 and 320.

In operation 520, the location estimation device 300 may control the rotation of the first and second camera modules 310 and 320 so that the first and second camera modules are directed toward the one vehicle.

In operation 530, the location estimation device 300 may obtain a first lateral angle value between the second camera module 320 and the one vehicle on the basis of the first camera module 310 and a second lateral angle value between the first camera module 310 and the one vehicle on the basis of the second camera module 320, at first timing at which the first and second camera modules 310 and 320 are directed toward the one vehicle.

In operation 540, the location estimation device 300 may obtain up and down angle values (first and second up and down angle values) of the first and second camera modules 310 and 320, which are based on perpendiculars that connect the first and second camera modules 310 and 320 and the reference plane, at the first timing.

In operation 550, the location estimation device 300 may estimate 3-D location coordinate values of the one vehicle according to triangulation based on the first and second lateral angle values and the first and second up and down angle values.

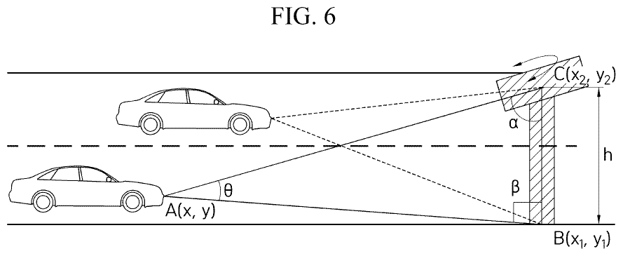

FIG. 6 is a diagram for describing a location estimation method according to another embodiment.

Referring to FIG. 6, the location estimation device 300 according to another embodiment may include only one camera module (e.g., the first camera module 310 of FIG. 3), and may estimate the location of a vehicle by the first camera module. In this case, the up and down angle of the first camera module 310 may be fixed.

The memory 340 of the location estimation device 300 stores the height h of the first camera module 310, an angle (β) (a reference plane and a tower are perpendicular to each other) between the first camera module 310 and the reference plane, and an up and down angle (α) at which the first camera module 310 looks at the license plate of the vehicle. In this case, the processor 350 may calculate a two-dimensional location coordinate value A(x, y) of the vehicle based on B(x1, y1) and C(x2, y2) because the processor is aware of the angle θ=180−(α+β).

x=x2−h*cos(θ), y=y2−h*sin(θ) [Equation 4]

According to another embodiment, the location estimation device 300 can detect one vehicle spaced apart from the first camera module 310 at a predetermined interval.

Various embodiments of this document and terms used in the embodiments are not intended to limit the technical characteristics, described in this document, to specific embodiments, and should be understood as including various changes, equivalents or alternatives of a corresponding embodiment. In relation to the description of the drawings, similar reference numerals may be used for similar or related components. A singular form of a noun corresponding to an item may include one item or a plurality of items unless explicitly described otherwise in the context. In this document, each of phrases, such as “A or B”, “at least one of A and B”, “at least one of A or B”, “A, B or C”, “at least one of A, B, and C”, and “at least one of A, B, or C”, may include any one of items listed along with a corresponding one of the phrases or all possible combinations of the listed items. Terms, such as “a first”, “a second”, or “the first” or “the second”, may be used to merely distinguish between a corresponding component and another corresponding component, and do not limit corresponding components in another aspect (e.g., importance or a sequence). If any (e.g., a first) component is described as being “coupled” or “connected” to another (e.g., a second) component along with a term “functionally” or “communicatively” or without such a term, this means that the any component may be coupled to the another component directly (e.g., in a wired way), wirelessly, or through a third component.

The term “module” used in various embodiments of this document may include a unit implemented as hardware, software or firmware, and may be interchangeably used with a term, such as logic, a logical block, a part, or a circuit. The module may be an integrated part, or a minimum unit of the part or a part thereof, which performs one or more functions. For example, according to an embodiment, the module may be implemented in the form of an application-specific integrated circuit (ASIC).

Various embodiments of this document may be embodied as software (e.g., a program) including one or more instructions stored in a storage medium (e.g., the memory 340 in FIG. 3) (e.g., embedded memory or external memory) readable by a machine (e.g., an electronic device). For example, a processor (e.g., the processor 350) of a device (e.g., the location estimation device 300) may invoke at least one of the one or more instructions stored in the storage medium, and may execute the instruction. This enables the machine to operate to perform at least one function based on the invoked at least one instruction. The one or more instructions may include a code generated by a complier or a code executable by an interpreter. The machine-readable storage media may be provided in the form of a non-transitory storage medium. In this case, “non-transitory” merely means that the storage medium is a tangible device and does not include a signal (e.g., electromagnetic wave). The term does not distinguish between a case where data is semi-permanently stored in the storage medium and a case where data is temporally stored in the storage medium.

According to an embodiment, the method according to various embodiments disclosed in this document may be included in a computer program product and provided. The computer program product may be traded as a product between a seller and a purchaser. The computer program product may be distributed in the form of a machine-readable storage medium (e.g., compact disc read only memory (CD-ROM)) or may be distributed through an app store (e.g., PlayStore™) or directly between two user devices (e.g., smartphones) or online (e.g., download or upload). In the case of the online distribution, at least some of the computer program products may be at least temporarily stored or provisionally generated in a machine-readable storage medium, such as the memory of the server of a manufacturer, the server of an app store or a relay server.

The components according to various embodiments of the present disclosure may be implemented in the form of software or hardware, such as a digital signal processor (DSP), a field programmable gate array (FPGA) or an application-specific integrated circuit (ASIC), and may perform given roles. The “components” are not components having meanings limited to software or hardware, and each component may be configured to reside on an addressable storage medium and may be configured to operate one or more processors. For example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

According to various embodiments, each (e.g., a module or a program) of the aforementioned components may include a single entity or a plurality of entities. According to various embodiments, one or more components of operations of the aforementioned components may be omitted or one or more other components or operations may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components are integrated. According to various embodiments, operations performed by a module, a program, or another component may be executed sequentially, in parallel, iteratively or heuristically, or one or more of the operations may be executed in different order or may be omitted, or one or more other operations may be added.

1. A location estimation device, comprising:
a communication module configured to provide a short-distance communication channel within a GPS or RTK shadow area;
first and second camera modules spaced apart from each other at a predetermined interval so that a road within the shadow area is photographed and each provided to be capable of being at least laterally rotated;
a processor functionally connected to the first camera module, the second camera module, and the communication module,
wherein the processor
obtains a first lateral angle value between the second camera module and one vehicle within the shadow area by using the first camera module,
obtains a second lateral angle value between the first camera module and the one vehicle by using the second camera module,
estimates a location of the one vehicle through triangulation using the first lateral angle value, the second lateral angle value, and a separation distance between the first and second cameras, and
transmits information related to the estimated location to the one vehicle through the short-distance communication channel.

2. The location estimation device of claim 1, wherein the processor obtains the first lateral angle value and the second lateral angle value on the basis of a license plate of the one vehicle.

3. The location estimation device of claim 2, further comprising memory in which a communication address corresponding to information on the license plate of the one vehicle is stored, wherein the processor transmits the estimated location to the one vehicle based on the communication address.

4. The location estimation device of claim 1, wherein the processor
tracks the license plate of the one vehicle by using the first and second camera modules, and
obtains the first lateral angle value and the second lateral angle value at timing at which the first and second camera modules correspond to each other in a state in which the first and second camera modules are directed toward the license plate of the one vehicle by controlling lateral rotation of the first and second camera modules.

5. The location estimation device of claim 1, wherein the processor
confirms first location information related to a three-dimensional location of the first camera module and second location information related to a three-dimensional location of the second camera module from a high definition map (HD map), and
checks the designated distance based on the first location information and the second location information.

6. The location estimation device of claim 1, wherein the processor
checks a height of each of the first and second camera modules with respect to a reference plane and first and second up and down angle values of the camera modules based on perpendiculars that connect the camera modules, respectively, and the reference plane, and
estimates a three-dimensional location of the one vehicle further based on the first and second up and down angle values.

7. The location estimation device of claim 6, wherein the processor estimates the three-dimensional location of the one vehicle further based on altitude of the road on which the one vehicle is travelling based on the first and second lateral angle values and an HD map.

8. The location estimation device of claim 1, wherein the first camera module and the second camera module are provided on left and right sides of the road on which the one vehicle is travelling, respectively.

9. The location estimation device of claim 1, wherein the first camera module and the second camera module are provided on left and right sides of the road on which the one vehicle is travelling, respectively.

10. A location estimation method using first and second camera modules spaced apart from each other at a designated distance so that a road within a shadow area is photographed and each provided to be capable of being rotated at least toward one side, the location estimation method comprising:
an operation of detecting one vehicle that travels on the road within the shadow area by using the first and second camera modules;
an operation of controlling rotation of the first camera module and the second camera module so that the first camera module and the second camera module are directed toward the one vehicle;
an operation of obtaining lateral angle values between the first and second camera modules, respectively, and the one vehicle on the basis of a line that connects the first camera module and the second camera module, at first timing at which the first and second camera modules are directed toward the one vehicle;
an operation of obtaining up and down angle values of the first and second camera modules, which are based on perpendiculars that connect the first and second camera modules and a reference plane, at the first timing; and
an operation of estimation a location of the one vehicle through triangulation based on the lateral angle values and the up and down angle values.
